(19) United States
(12) Patent Application Publication
(10) Pub. No.: US 2012/0081678 A1
(43) Pub. Date: Apr. 5, 2012

(54) PROJECTION DISPLAY APPARATUS AND IMAGE ADJUSTMENT METHOD

(75) Inventors: Yoshinao HIRANUMA, Osaka (JP); Tomoya TERAUCHI, Osaka (JP); Susumu TANASE, Osaka (JP); Takaaki ABE, Osaka (JP); Masahiro Haraguchi, Osaka (JP); Noboru Yoshinobe, Sunoto-City (JP)

(73) Assignee: SANYO ELECTRIC CO., LTD., Osaka (JP)

(21) Appl. No.: 13/250,907

(22) Filed: Sep. 30, 2011

(30) Foreign Application Priority Data
Sep. 30, 2010 (JP) 2010-222443

(51) Int. Cl. G03B 21/14

(52) U.S. Cl. 353/69; 353/121

(57) ABSTRACT

A projection display apparatus displays a test pattern image formed of at least parts of three or more line segments defining three or more intersection points. The projection display apparatus computes a positional relationship between the projection display apparatus and the projection surface, based on the three or more intersection points. The test pattern image has a distortion in an opposite direction to a direction of the lens.

### CROSS REFERENCE TO RELATED APPLICATIONS

This application is based upon and claims the benefit of priority from prior Japanese Patent Application No. 2010-222443, filed on Sep. 30, 2010; the entire contents of which are incorporated herein by reference.

### BACKGROUND OF THE INVENTION

1. Field of the Invention

The present invention relates to a projection display apparatus having: an imager that modulates light emitted from a light source; and a projection unit that projects light emitted from the imager, onto a projection surface, and an image adjustment method applied to the projection display apparatus.

2. Description of the Related Art

Conventionally, there has been known a projection display apparatus including: an imager that modulates light emitted from a light source; and a projection unit that projects light emitted from the image; onto a projection surface.

In this apparatus, an image projected onto the projection surface is distorted in shape depending on a positional relationship between the projection display apparatus and the projection surface.

On the other hand, there has been proposed a method for adjusting a shape of an image in accordance with the processing steps that follows (for example, JP-A-2005-318652). First, a projection display apparatus projects a test pattern image formed in a rectangular shape, onto a projection surface. Second, the projection display apparatus captures the test pattern image projected onto the projection surface, and specifies a coordinate of each of four corners of the test pattern image in the projection surface. Third, the projection display apparatus specifies a positional relationship between the projection display apparatus and the projection surface, based on the coordinate of each of the four corners of the, test pattern image in the projection surface, and adjusts the shape of the image projected onto the projection surface.

Incidentally, in a case where a distance between a projection display apparatus and a projection surface is very short, there is a need to employ a lens with its large distortion such as a widely angled lens in order to capture a test pattern image by means of an imaging element arranged in the projection display apparatus.

In such a case, a captured image (a test pattern image) captured by the imaging element is distorted in shape, thus requiring a large amount of computation resources in order to correct the distortion of the captured image). Therefore, an increasing amount of processing time or a higher cost is required to adjust the shape of the image projected onto the projection surface.

### SUMMARY OF THE INVENTION

A projection display apparatus according to a first feature has an imager (liquid crystal panel 50) that modulates light emitted from a light source (light source 10) and a projection unit (projection unit 110) that projects light emitted from the imager onto a projection surface. The projection display apparatus includes: an element control unit (element control unit 260) that controls the imager so as to display a test pattern image formed of at least parts of three or more line segments defining three or more intersection points; an acquisition unit (acquisition unit 230) that acquires a captured image of the test pattern image output from an imaging element (imaging element 300) that captures the test pattern image projected onto the projection surface; a computation unit (computation unit 250) that specifies three or more intersection points from the three or more line segments included in the captured image, based on the captured image acquired by the acquisition unit and that computes a positional relationship between the projection display apparatus and the projection surface, based on the three or more intersection points; and an adjustment unit (adjustment unit 280) that adjusts the image provided on the projection surface, based on the positional relationship between the projection display apparatus and the projection surface. The imaging element captures the test pattern image through a lens having a distortion in a positive direction or in a negative direction. The element control unit controls the imager so as to display the test pattern image having a distortion in an opposite direction to a direction of the lens.

In the first feature, the distortion included in the test pattern image is a yarn winding distortion.

In the first feature, the imager is disposed at a position shifted from an optical axis center of the projection unit.

In the first feature, the projection unit is comprised of a lens group and a reflection mirror that reflects light transmitting the lens group onto the projection surface.

An image adjustment method according to a second feature is applied to a projection display apparatus having an imager that modulates light emitted from a light source and a projection unit that projects light emitted from the imager onto a projection surface. The image adjustment method includes: the step A of displaying a test pattern image formed of at least parts of three or more line segments defining three or more intersection points; the step B of imaging the test pattern image projected onto the projection surface through a lens having a distortion in a positive direction or in a negative direction and acquiring a captured image of the test pattern image; and the step C of computing a positional relationship between the projection display apparatus and the projection surface, based on the captured image, and adjusting an image projected onto the projection surface, based on the positional relationship between the projection display apparatus and the projection surface. The step A includes displaying the test pattern image having a distortion in an opposite direction of a direction of the lens.

### BRIEF DESCRIPTION OF THE DRAWINGS

FIG. 1 is a view showing a schematic of a projection display apparatus 100 according to a first embodiment.

FIG. 2 is a view showing a configuration of the projection display apparatus 100 according to the first embodiment.

FIG. 3 is a view for explaining a shift of a liquid crystal panel 50 according to the first embodiment.

FIG. 4 is a block diagram depicting a control unit 200 according to the first embodiment.

FIG. 5 is a view showing an example of a storage test pattern image according to the first embodiment.

FIG. 6 is a view showing an example of a storage test pattern image according to the first embodiment.

FIG. 7 is a view showing an example of a storage test pattern image according to the first embodiment.

FIG. 8 is a view showing an example of a storage test pattern image according to the first embodiment.

FIG. 9 is a view for explaining a distortion of the test pattern image according to the first embodiment.

FIG. 10 is a view for explaining a distortion of a lens according to the first embodiment.

FIG. 11 is a view for explaining correction of the lens distortion according to the first embodiment.

FIG. 12 is a view for explaining computation of the test pattern image according to the first embodiment.

FIG. 13 is a view showing an example of a captured test pattern image according to the first embodiment.

FIG. 14 is a view showing an example of a captured test pattern image according to the first embodiment.

FIG. 15 is a view for explaining a method for computing an intersection point included in a projected test pattern image according to the first embodiment.

FIG. 16 is a flowchart showing an operation of the projection display apparatus 100 according to the first embodiment.

FIG. 17 is a flowchart showing an operation of the projection display apparatus 100 according to the first embodiment.

FIG. 18 is a view for explaining a shift of a liquid crystal panel 50 according to modification example 1.

### DETAILED DESCRIPTION OF THE EMBODIMENTS

Hereinafter, a projection display apparatus according to the embodiments of the present invention will be described with reference to the drawings. In the following description of the drawings, same or similar constituent elements are designated by same or similar reference numerals.

It should be noted that the drawings are schematically shown and that rates of each dimension or the like are different from the actual ones. Therefore, specific dimensions or the like should be determined in consideration of the following description. Moreover, of course, constituent elements with their different dimensional interrelationships and ratios are included in the respective drawings as well.

### Overview of the Embodiments

A projection display apparatus according to the embodiments has: an imager that modulates light emitted from a light source; and a projection unit that projects light emitted from the imager, onto a projection surface. The projection display apparatus includes: an element control unit that controls the imager so as to display a test pattern image formed of at least parts of three or more line segments defining three or more intersection points; an acquisition unit that acquires a captured image of a test pattern image from the imager that captures the test pattern image projected onto the projection surface; a computation unit that specifies three or more intersection points from the three or more line segments included in the captured image and that computes a positional relationship between the projection display apparatus and the projection surface, based on the three or more intersection points; and an adjustment unit that adjusts an image projected onto the projection surface, based on the positional relationship between the projection display apparatus and the projection surface. The imaging element captures a test pattern image through a lens having a distortion in a positive direction or in a negative direction. The element control unit controls the imager so as to display a test pattern image having a distortion in an opposite direction to that of the lens.

In the embodiment, the element control unit controls the imager so as to display the test pattern image having the distortion in the opposite direction to that of the lens. Therefore, it is possible to prepare in advance the test pattern image having the distortion in the opposite direction to that of the lens, the distortion of the captured image of the test pattern image is cancelled, so that a processing time or a cost required to adjust the shape of the image projected onto the projection surface can be restrained.

The projection display apparatus may have a specifying unit that specifies three or more line segments included in a captured image, based on the captured image acquired by the acquisition unit, and that specifies three or more intersection points included in the captured image, based on the three or more line segments included in the captured image. The computation unit computes a positional relationship between the projection display apparatus and the projection surface, based on the three or more intersection points included in the test pattern image and the three or more intersection points included in the captured image.

### First Embodiment

### (Outline of Projection Display Apparatus)

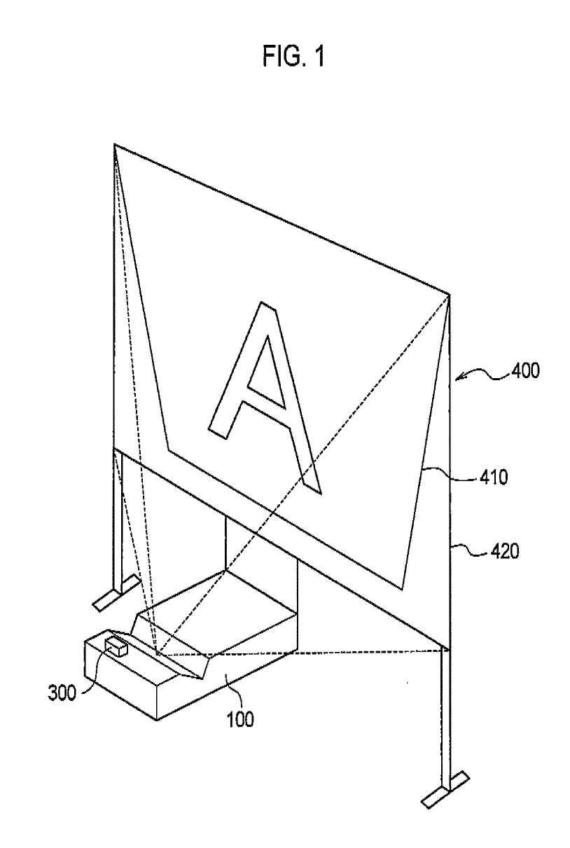

Hereinafter, a projection display apparatus according to the first embodiment will be described with reference to the drawings. FIG. 1 is a view showing a schematic of a projection display apparatus 100 according to the first embodiment. The first embodiment illustrates a case in which a distance between the projection display apparatus 100 and a projection surface 400 are very close to each other.

As shown in FIG. 1, an imaging element 300 is arranged in the projection display apparatus 100. In addition, the projection display apparatus 100 projects image light onto a projection surface 400.

The imaging element 300 captures an image on the projection surface 400. That is the imaging element 300 detects reflection light of the image light projected onto the projection surface 400 by means of the projection display apparatus 100. The imaging element 300 outputs a captured image to the projection display apparatus 100 via a predetermined line. The imaging element 300 may be incorporated in the projection display apparatus 100 or may be provided together with the projection display apparatus 100.

Here, a distance between the projection display apparatus 100 and the projection surface 400 is very close, and therefore, the imaging element 300 captures a test pattern image through a lens having a distortion in a positive direction or in a negative direction. For example, the distortion included in the lens is a barrel distortion.

The projection surface 400 is configured with a screen or the like. A range in which the projection display apparatus 100 is capable of projecting image light (a projectable range 410) is formed on the projection surface 400. In addition, the projection surface 400 has a display frame 420 configured with an outer frame of the screen.

### (Configuration of Projection Display Apparatus)

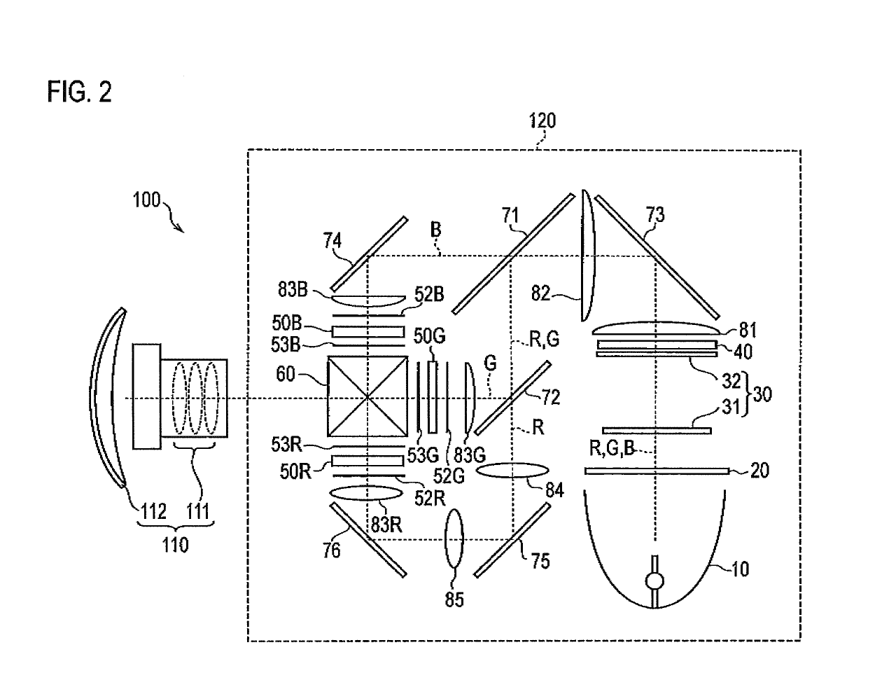

Hereinafter, the projection display apparatus according to the first embodiment will be described with reference to the drawings. FIG. 2 is a view showing a configuration of the projection display apparatus 100 according to the first embodiment.

As shown in FIG. 2, the projection display apparatus 100 has a projection unit 110 and an illumination device 120.

The projection unit 110 projects the image light emitted from the illumination device 120 onto a projection surface (not shown) or the like. Specifically, the projection unit 110 has: a projection lens group 111 that projects the image light emitted from the illumination device 120, onto a projection surface (not shown); and a reflection mirror 112 that reflects the image light emitted from the projection lens group, onto the projection surface side. The reflection mirror 112 is a recessed surface mirror having a non-spherical reflection surface, for example.

Firstly, the illumination device 120 has a light source 10, a UV/IR cut filter 20, a fly eye lens unit 30, a PBS array 40, a plurality of liquid crystal panels 50 (a liquid crystal panel 50R, a liquid crystal panel 50G, and a liquid crystal panel 50B), and a cross dichroic prism 60.

The light source 10 is a light source emitting incandescent light (for example, a UHP lamp or a xenon lamp) or the like. That is, the incandescent light that the light source 10 emits includes red component light R, green component light G, and blue component light B.

The UV/UR, cut filter 20 transmits a visible light component (red component light R, green component light G, and blue component light B). The UV/IR cut filter 20 shields an infrared light component or an ultraviolet light component.

The fly eye lens unit 30 equalizes the light that the light source 10 emits. Specifically, the fly eye lens 30 is configured with a flay eye lens 31 and a fly eye lens 32. The fly eye lens 31 and the fly eye lens 32 are respectively configured with a plurality of microscopic lenses. Each of the microscopic lenses focuses the light that the light source 10 emits, so that a full surface of the liquid crystal panel 50 is irradiated with the light that the light source 10 emits.

The PBS array 40 equalizes a polarization state of light emitted from the fly eye lens unit 30. For example, the PBS array 40 equalizes the light that emitted from the fly eye lens unit 30, to S-polarization (or P-polarization).

The liquid crystal panel 50R modulates red component light R, based on a red output signal Rₒᵤₜ. On a side on which light is incident to the liquid crystal panel 50R, an incidence side polarization plate 52R is arranged which is adapted to transmit light having one polarization direction (for example, S-polarization) and shield light having another polarization direction (for example, P-polarization). On a side on which light is emitted from the liquid crystal panel 50R, an emission side polarization plate 53R is arranged which is adapted to shield light having one polarization direction (for example, S-polarization) and transmit light having another polarization direction (for example, P-polarization).

The liquid crystal panel 50G modulates green component light G, based on a green output signal Gₒᵤₜ. On a side on which light is incident to the liquid crystal panel 50G, an incidence side polarization plate 52G is arranged which is adapted to transmit light having one polarization direction (for example, S-polarization) and shield light having another polarization direction (for example, P-polarization). On a side on which light is emitted from the liquid crystal panel 50G, an emission side polarization plate 53G is arranged which is adapted to shield light having one polarization direction (for example, S-polarization) and transmit light having another polarization direction (for example, P-polarization).

The liquid crystal panel 50B modulates blue component light B, based on a blue output signal Bₒᵤₜ. On a side on which light is incident to the liquid crystal panel 50B, an incidence side polarization plate 52B is arranged which is adapted to transmit light having one polarization direction (for example, S-polarization) and shield light having another polarization direction (for example, P-polarization). On a side on which light is emitted from the liquid crystal panel 50B, an emission side polarization plate 53B is arranged which is adapted to shield light having one polarization direction (for example, S-polarization) and transmit light having another polarization direction (for example, P-polarization).

The red output signal Rₒᵤₜ, the green output signal Gₒᵤₜ, and the blue output signal Bₒᵤₜ configures an image output signal. The image output signal is a signal in a plurality of pixels that configures one frame.

Here, on each liquid crystal panel 50, a compensation plate (not shown) that improves a contrast ratio or a transmission rate may be arranged. In addition, each polarization plate may have a pre-polarization plate that reduces a light quantity or a thermal load of the light incident to such each polarization plate.

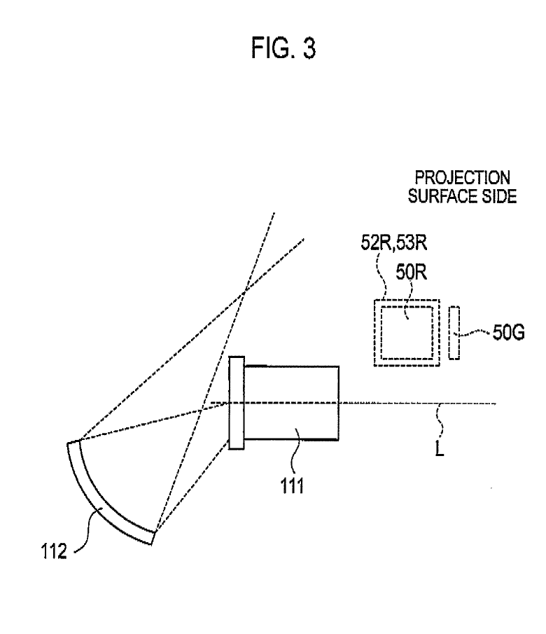

In the first embodiment, a distance between the projection display apparatus 100 and the projection surface 400 is very close to each other, and therefore, the liquid crystal panel 50, as shown in FIG. 3, is disposed at a position shifted from an optical axis center L of the projection unit 110. Specifically, a center of the liquid crystal panel 50 shifts to the side of the projection surface 400 relative to the optical axis center L of the projection unit 110. However, it should be noted that a shifting direction of the liquid crystal panel 50 depends on a configuration of the projection unit 110.

The cross dichroic prism 60 configures a color combining unit that combines light beams emitted from the liquid crystal panel 50R, the liquid crystal panel 50G, and the liquid crystal panel 50B. The combined light beams emitted from the cross dichroic prism 60 are guided to the projection unit 110.

Secondly, the illumination device 120 has a mirror group (a mirror 71 to a mirror 76) and a lens group (a lens 81 to a lens 85).

The mirror 71 is a dichroic mirror that transmits blue component light B and reflect red component light R and green component light G. The mirror 72 is a dichroic mirror that transmits red component light R and reflect green component light G. The mirror 71 and the mirror 72 configure a color separation unit that separates red component light R, green component light G, and blue component light B from each other.

The mirror 73 reflects red component light R, green component light G, and blue component light B, and guides the red component light R, the green component light G, and the blue component light G to the side of the mirror 71. The mirror 74 reflects blue component light B, and guides the blue component light B to the side of the liquid crystal panel 50B. The mirror 75 and the mirror 76 reflects red component R, and guides the red component light R to the side of the liquid crystal panel 50R.

The lens 81 is a condenser lens that focuses light that emitted from the PBS array 40. The lens 82 is a condenser lens that focuses light that reflected by the mirror 73.

The lens 83R substantially parallelizes red component light R so that the liquid crystal panel 50R is irradiated with the red component light R. The lens 83G substantially parallelizes green component light G so that the liquid crystal panel 50G is irradiated with the green component light G. The lens 83B substantially parallelizes blue component light B so that the liquid crystal panel 50B is irradiated with the blue component light B.

The lens 84 and the lens 85 are relay lenses that substantially form red component light R as an image on the liquid crystal panel 50R while restraining expansion of the red component light R.

### (Configuration of Control Unit)

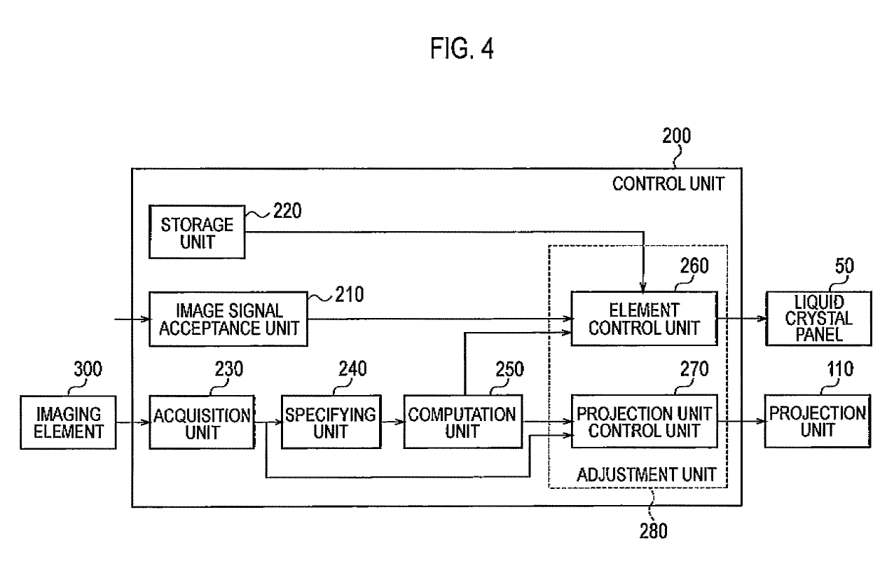

Hereinafter, a control unit according to the first embodiment will be described with reference to the drawings. FIG. 4 is a block diagram depicting a control unit 200 according to the first embodiment. The control unit 200 is arranged in the projection display apparatus 100, and controls the projection display apparatus 100.

The control unit 200 converts an image input signal to an image output signal. The image input signal is configured with a red input signal Rᵢₙ, a green input signal Gᵢₙ, and a blue input signal Bᵢₙ. The image output signal is configured with a red output signal Rₒᵤₜ, a green output signal Gₒᵤₜ, and a blue output signal Bₒᵤₜ. The image input signal and the image output signal are signals input in a plurality of pixels that configure one frame.

As shown in FIG. 4, the control unit 200 has an image signal acceptance unit 210, a storage unit 220, an acquisition unit 230, a specifying unit 240, a computation unit 250, an element control unit 260, and a projection unit adjustment unit 270.

The image signal acceptance unit 210 accepts an image input signal from an external device (not shown) such as a cellular phone, a personal computer, a USB memory, a DVD, or a TV tuner.

The storage unit 220 stores a variety of information. Specifically, the storage unit 220 stores: a frame detection pattern image employed to detect a display frame 420; a focus adjustment image employed to adjust a focus; and a test pattern image employed to compute a positional relationship between the projection display apparatus 100 and the projection surface 400. Alternatively, the storage unit 220 may store an exposure adjustment image employed to adjust an exposure value.

The test pattern image is an image formed of at least parts of three or more line segments defining three or more intersection points. In addition, the three or more line segments respectively haves a tilt relative to a predetermined line.

The imaging element 300 outputs a captured image along a predetermined line, as described above. For example, the predetermined line is a pixel array in a horizontal direction, and an orientation of the predetermined line is a horizontal direction.

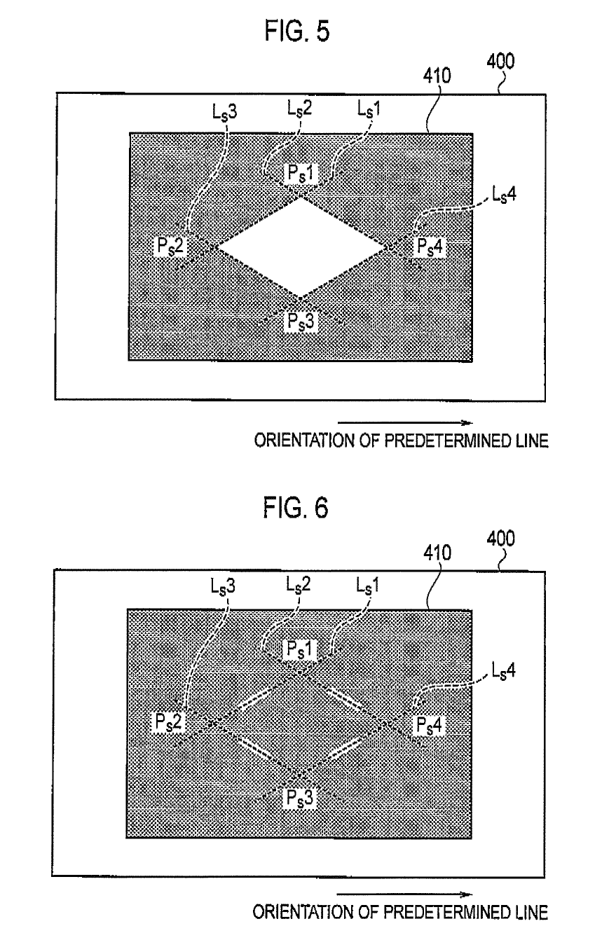

Hereinafter, an example of a test pattern image will be described with reference to FIG. 5 to FIG. 8. As shown in FIG. 5 to FIG. 8, the test pattern image is an image formed of at least parts of four line segments (Lₛ1 to Lₛ4) defining four intersection points (Pₛ1 to Pₛ4). In the first embodiment, the four line segments (Lₛ1 to Lₛ4) are represented by a difference (edge) in contrast or brightness.

In detail, as shown in FIG. 5, the test pattern image may be an outlined rhombic shape on a black background. Here, four edges of the outlined rhombic shape define at least parts of the four line segments (Lₛ1 to Lₛ4). The four line segments (Lₛ1 to Lₛ4) respectively have a tilt relative to a predetermined line (a horizontal direction).

Alternatively, as shown in FIG. 6, the test pattern image may be outlined line segments on a black background. The outlined line segments define parts of four edges of the outlined rhombic shape shown in FIG. 5. Here, the outlined line segments define at least parts of the four line segments (Lₛ1 to Lₛ4). The four line segments (Lₛ1 to Lₛ4) respectively have a tilt relative to a predetermined line (a horizontal direction).

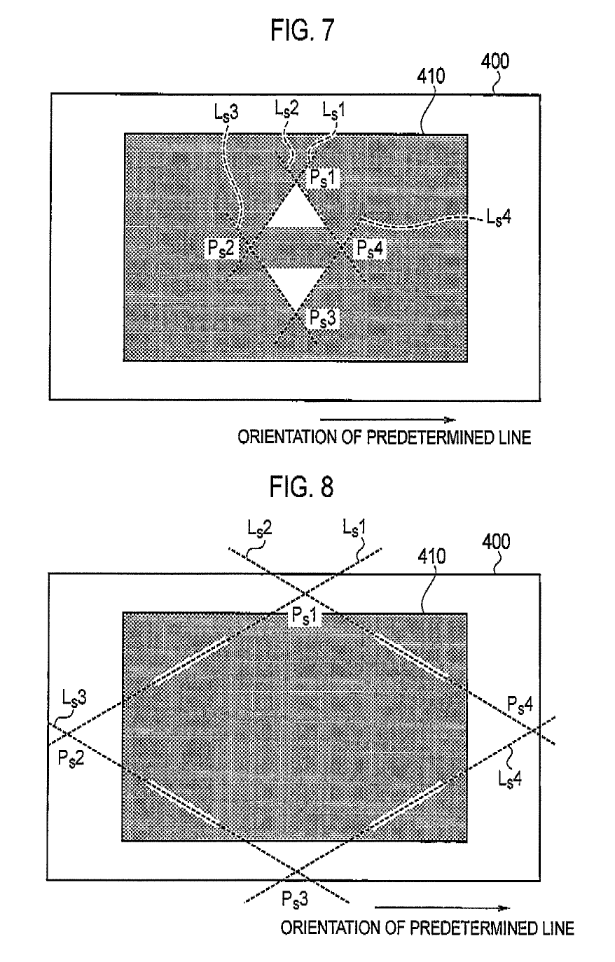

Alternatively, as shown in FIG. 7, the test pattern image may be one pair of outlined triangular shapes on a black background. Here, two edges of one pair of the outlined triangular shapes form at least parts of four line segments (Lₛ1 to Lₛ4). The four line segments (Lₛ1 to Lₛ4) respectively have a tilt relative to a predetermined line (a horizontal direction).

Alternatively, as shown in FIG. 8, the test pattern image may be outlined line segments on a black background. Here, the outlined line segments form at least parts of four line segments (Lₛ1 to Lₛ4). As shown in FIG. 8, four intersection points (Pₛ1 to Pₛ4) defined with the four line segments (Lₛ1 to Lₛ4) may be arranged at the outside of the projectable range 410. The four segments (Lₛ1 to Ls4) respectively have a tilt relative to a predetermined line (a horizontal direction).

Here, in the first embodiment, as described above, the imaging element 300 captures a test pattern image through a lens having a distortion in a positive direction or in a negative position. For example, the distortion included in the lens is a barrel distortion.

Therefore, the test pattern image stored in the storage unit 220 (that is, the test pattern image projected onto the projection surface 400) needs to have a distortion in an opposite direction to that of the lens.

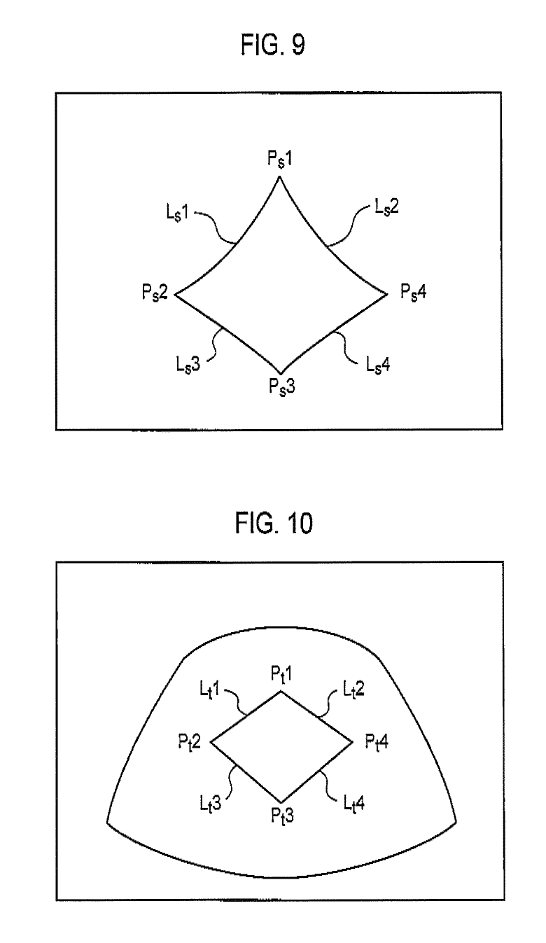

For example, as shown in FIG. 9, the test pattern image stored in the storage unit 220 has a yawn winding distortion. In this manner, the test pattern image captured by means of the imaging element 300 through the lens having the distortion in the positive direction or in the negative direction is acquired in a state in which a barrel distortion has been added, as shown in FIG. 10.

Lₛ1 to Lₛ4 are line segments in the test pattern image stored in the storage unit 220, and Pₛ1 to Pₛ4 designate intersection points in the test pattern image stored in the storage unit 220. In addition, Lₜ1 to Lₜ4 are line segments in the test pattern image captured by the imaging element 300. Pₜ1 to Pₜ4 are intersection points in the test pattern image captured by the imaging element 300.

Hereinafter, computation of a test pattern image having a distortion in an opposite direction to that of a lens will be described with reference to the drawings.

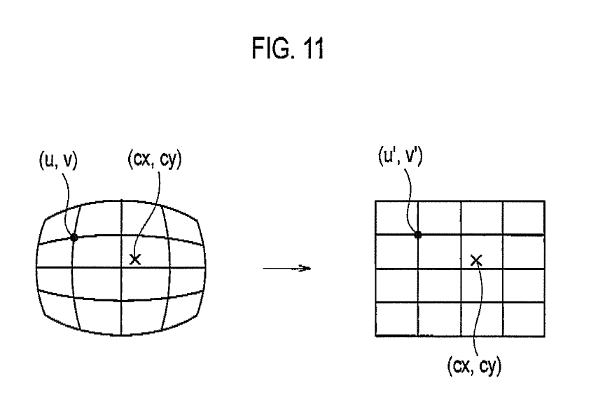

First, parameters for correcting a lens distortion will be described with reference to FIG. 11. Here, a center pixel in which no distortion occurs is represented by (cx, cy), a coordinate before lens distortion correction is represented by (u, v), and a coordinate after lens distortion correction is represented by ‘u’, v′). In such a case, the coordinate after lens distortion correction is represented by the formula below.

[Formula 1]

u′=(u−cx)(1+q₁r²+q₂r⁴)+2p₁(u−cx)(v−cy)+p₂(r²+2(u−cx)²)+cx Formula (1)

v′=(v−cy)(1+q₁r²+q₂r⁴)+p₁(r²+2(v−cy)²)+2p₂(u−cx)(v−cy)+cy Formula (2)

In the formula, r²=(u−cx)²+(v−cy)², p₁, p₂, q₁, and q₂ are predetermined coefficients. Such distortion correction is known as a Zang technique (for example, “A Flexible new technique for camera calibration”, IEEE Transactions on Pattern Analysis and Machine Intelligence, 22 (11): 1330-1334, 2000).

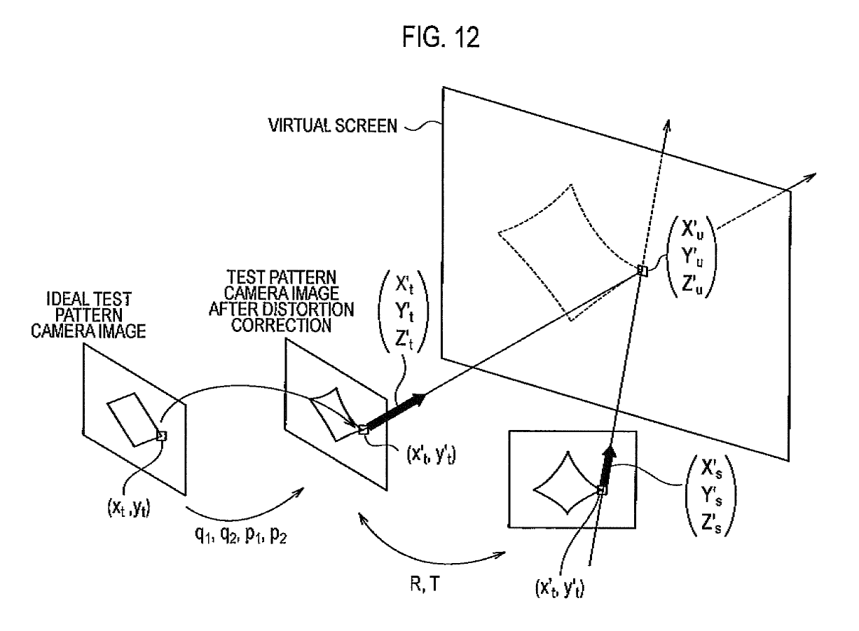

Second, parameters for converting a coordinate in a two-dimensional space to a coordinate in a three-dimensional space will be described with reference FIG. 12. Here, a relationship between a coordinate (xₜ, yₜ, 1) in a two-dimensional space of a captured image and a coordinate (Xₜ, Yₜ, Zₜ) in a three-dimensional space in which a focal point of the imaging element 300 is defined as an origin is represented by the formula below.

$$\begin{matrix}[ Formula 2 ] & \\ {λ}_{t} ( \begin{matrix}{X}_{t} 1 \\ {Y}_{t} 1 \\ {Z}_{t} 1\end{matrix} ) = At ( \begin{matrix}{x}_{t} \\ {y}_{t} \\ 1\end{matrix} ) & Formula ( 3 )\end{matrix}$$

In the formula, At is a conversion matrix of 3×3, and can be acquired in advance by means of preprocessing such as calibration. That is, At is a known parameter, In addition, λₜ is a parameter.

Similarly, a relationship between a coordinate (xₛ, yₛ, 1) in a two-dimensional space of an image stored in the projection display apparatus 100 and a coordinate (Xₛ, Yₛ, Zₛ) in a three-dimensional space in which a focal point of the projection display apparatus 100 is defined as an origin is represented by the formula below.

$$\begin{matrix}[ Formula 3 ] & \\ {λ}_{s} ( \begin{matrix}{X}_{s} \\ {Y}_{s} \\ {Z}_{s}\end{matrix} ) = As ( \begin{matrix}{x}_{s} \\ {y}_{s} \\ 1\end{matrix} ) & Formula ( 4 )\end{matrix}$$

In the formula, As is a conversion matrix of 3×3, and can be acquired in advance by means of preprocessing such as calibration, That is, As is a known parameter. In addition, λₛ is a parameter.

Third, a relationship between a coordinate in a three-dimensional space in which a focal point of the imaging element 300 is defined as an origin and a coordinate in a three-dimensional space in which a focal point of the projection display apparatus 100 is defined as an origin, will be described with reference to FIG. 12. A coordinate (Xₜ, Yₜ, Zₜ) in a three-dimensional space with a focal point of the imaging element 300 and a coordinate (Xₛ, Yₛ, Zₛ) in a three-dimensional space in which a focal point of the projection display apparatus 100 is defined as an origin have the following relationship on a virtual projection surface.

$$\begin{matrix}[ Formula 4 ] & \\ ( \begin{matrix}{X}_{s} \\ {Y}_{s} \\ {Z}_{s}\end{matrix} ) = R ( \begin{matrix}{X}_{t} \\ {Y}_{t} \\ {Z}_{t}\end{matrix} ) + T & Formula ( 5 )\end{matrix}$$

In the formula, an optical axis of the projection display apparatus 100 and an orientation (an image capturing direction) of the imaging element 300 are known, and therefore, a parameter R indicating a rotational component is known. Similarly, relative positions of the projection display apparatus 100 and the imaging element 300 are known, and therefore, a parameter T indicating a translational component is also known. A parameter R is a conversion matrix of 3×3, and the parameter T is a conversion matrix of 3×1.

Fourth, in a test pattern image captured by the imaging element 300, a coordinate (xₜ, yₜ, 1) of an ideal test pattern (hereinafter, an ideal test pattern camera image) is acquired. The ideal test pattern camera image is formed in a shape the same as those of the test pattern captures shown in FIG. 5 to FIG. 8, for example. The ideal test pattern camera image has a coordinate in a two-dimensional space.

Fifth, the coordinate (xₜ, yₜ, 1) of the ideal test pattern camera image is converted by employing the abovementioned formula (1) and formula (2). In this manner, a coordinate of a test pattern image whose lens distortion has been corrected, i.e., a coordinate (xₜ′, yₜ′, 1) of a test pattern image (hereinafter, a test patter camera image after distortion conversion) to which a distortion in an opposite direction to that of a lens has been assigned is acquired. The test pattern camera image after distortion correction has a coordinate in a two-dimensional space.

Sixth, a coordinate (Xₜ′, Yₜ′, Zₜ′) of the test pattern camera image after distortion correction in a three-dimensional space in which a focal point of the imaging element 300 is defined as an origin is computed by the formula below.

$$\begin{matrix}[ Formula 5 ] & \\ ( \begin{matrix}{X}_{t}^{′} \\ {Y}_{t}^{′} \\ {Z}_{t}^{′}\end{matrix} ) = {At}^{- 1} {λ}_{t}^{′} ( \begin{matrix}{x}_{t}^{′} \\ {y}_{t}^{′} \\ {1}_{t}\end{matrix} ) & Formula ( 6 )\end{matrix}$$

Seventh, a coordinate (Xₛ′, Yₛ′, Zₛ′) of the test pattern camera image after distortion correction in a three-dimensional space in which a focal point of the projection display apparatus 100 is defined as an origin is computed by the formula below.

$$\begin{matrix}[ Formula 6 ] & \\ ( \begin{matrix}{X}_{s}^{′} \\ {Y}_{t}^{′} \\ {Z}_{t}^{′}\end{matrix} ) = R ( \begin{matrix}{X}_{t}^{′} \\ {Y}_{t}^{′} \\ {Z}_{t}^{′}\end{matrix} ) + ( \begin{matrix}{t}_{1} \\ {t}_{2} \\ {t}_{3}\end{matrix} ) & Formula ( 7 )\end{matrix}$$

provided if,

$$T = ( \begin{matrix}{t}_{1} \\ {t}_{2} \\ {t}_{3}\end{matrix} )$$

Eighth, in a three-dimensional space in which a focal point of the projection display apparatus 100 is defined as an origin, in a case where a virtual projection surface is represented by aXₛ+bYₛ+cZₛ+d=0, a coordinate (Xᵤ′, Yᵤ′, Zᵤ′) of the test pattern camera image after distortion correction in the virtual projection surface is computed by the formula below.

$$\begin{matrix}[ Formula 7 ] & \\ ( \begin{matrix}{X}_{u}^{′} \\ {Y}_{u}^{′} \\ {Z}_{u}^{′}\end{matrix} ) = - \frac{{at}_{1} + {bt}_{2} + {ct}_{3} + d}{{ax}_{t}^{′} + {by}_{t}^{′} + {cz}_{t}^{′}} R ( \begin{matrix}{X}_{t}^{′} \\ {Y}_{t}^{′} \\ {Z}_{t}^{′}\end{matrix} ) + ( \begin{matrix}{t}_{1} \\ {t}_{2} \\ {t}_{3}\end{matrix} ) & Formula ( 8 )\end{matrix}$$

Ninth, a coordinate (xₛ′, yₛ′, 1) of the test pattern camera image after distortion correction in a two-dimensional space of an image stored in the projection display apparatus 100 is computed by the formula below.

$$\begin{matrix}[ Formula 8 ] & \\ ( \begin{matrix}{x}_{s}^{′} \\ {y}_{s}^{′} \\ 1\end{matrix} ) = {λ}_{s}^{′} {As}^{- 1} ( \begin{matrix}{X}_{u}^{′} \\ {Y}_{u}^{′} \\ {Z}_{u}^{′}\end{matrix} ) & Formula ( 9 )\end{matrix}$$

Turning to FIG. 4, the acquisition unit 230 acquires a captured image output from the imaging element 300 along a predetermined line. For example, the acquisition unit 230 acquires a captured image of a frame detection pattern image output from the imaging element 300 in a predetermined line. The acquisition unit 230 acquires a captured image of a focus adjustment image output from the imaging element 230 along a predetermined line. The acquisition unit 230 acquires a captured image of a test pattern image output from the imaging element 300 along a predetermined line. Alternatively, the acquisition unit 230 may acquire a captured image of an exposure adjustment image output from the imaging element 300 along a predetermined line.

The specifying unit 240 specifies three or more line segments included in a captured image, based on the captured image acquired in each predetermined line by means of the acquisition unit 230. Subsequently, the specifying unit 240 acquires three or more intersection points included in the captured image, based on the three or more line segments included in the captured image.

Specifically, the specifying unit 240 acquires the three or more intersection points included in the captured image, in accordance with the procedure below. Here, a case in which a test pattern image is an image shown in FIG. 5 (an outlined rhombic shape) is illustrated.

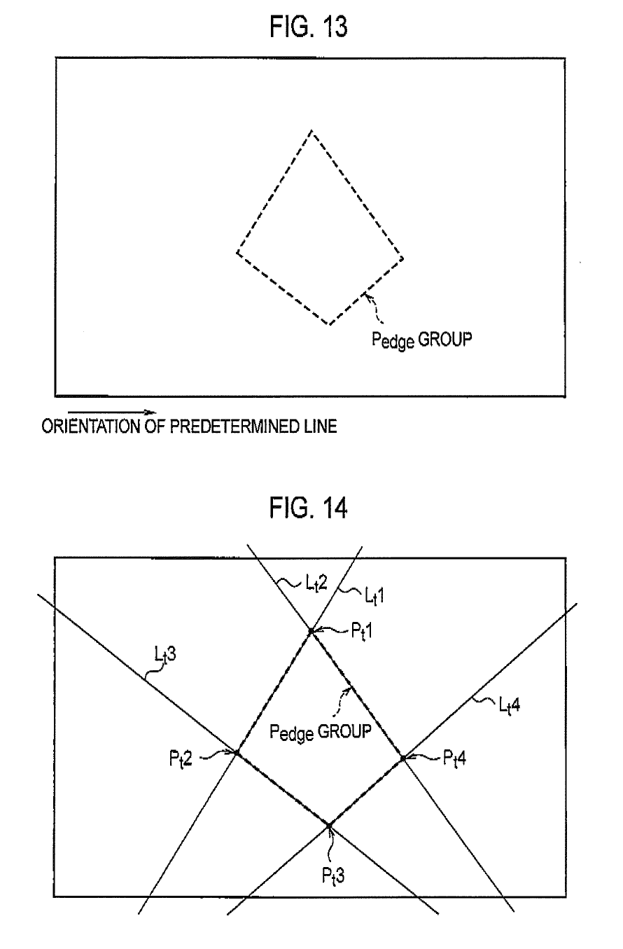

First, the specifying unit 240, as shown in FIG. 13, acquires a dot group P_{edge} having a difference (edge) in contrast or brightness, based on a captured image acquired in each predetermined line by means of the acquisition unit 230. That is, the specifying unit 240 specifies a point group P_{edge} that corresponds to four edges of an outlined rhombic shape of a test pattern image.

Second, the specifying unit 240, as shown in FIG. 14, specifies four line segments (Lₜ1 to Lₜ4) included in a captured image, based on the point group P_{edge}. That is, the specifying unit 240 specifies four line segments (Lₜ1 to Lₜ4) that correspond to four line segments (Lₛ1 to Lₛ4) included in a test pattern image.

Third, the specific unit 240, as shown in FIG. 14, specifies four intersection points (Pₜ1 to Pₜ4) included in a captured image, based on the four line segments (Lₜ1 to Lₜ4). That is, the specifying unit 240 specifies four intersection points (Pₜ1 to Pₜ4) that correspond to four intersection points (Pₜ1 to Pₜ4) included in a test pattern image.

The computation unit 250 computes a positional relationship between the projection display apparatus 100 and the projection surface 400, based on three or more intersection points (for example, Pₜ1 to Pₜ4) included in a test pattern image and three or more intersection points (for example, Pₜ1 to Pₜ4) included in a captured image. Specifically, the computation unit 250 computes a displacement quantity between an optical axis N of the projection display apparatus 100 (a projection unit 110) and a normal line M of the projection surface 400.

Hereinafter, a test pattern image stored in the storage unit 220 is referred to as a storage test pattern image. A test pattern image included in a captured image is referred to as a captured image. A test pattern image projected onto the projection surface 400 is referred to as a projected test pattern image.

First, the computation unit 250 computes a coordinate of four intersection points (Pᵤ1 to Pᵤ4) included in a protected test pattern image. Here, a description will be given by way of example of the intersection point Pₛ1 of the storage test pattern image, the intersection point Pₜ1 of the captured test pattern image, and the intersection point Pᵤ1 of the projected test pattern image. The intersection point Pₛ1, the intersection point Pₜ1, and the intersection point Pᵤ1 are intersection points that correspond to each other.

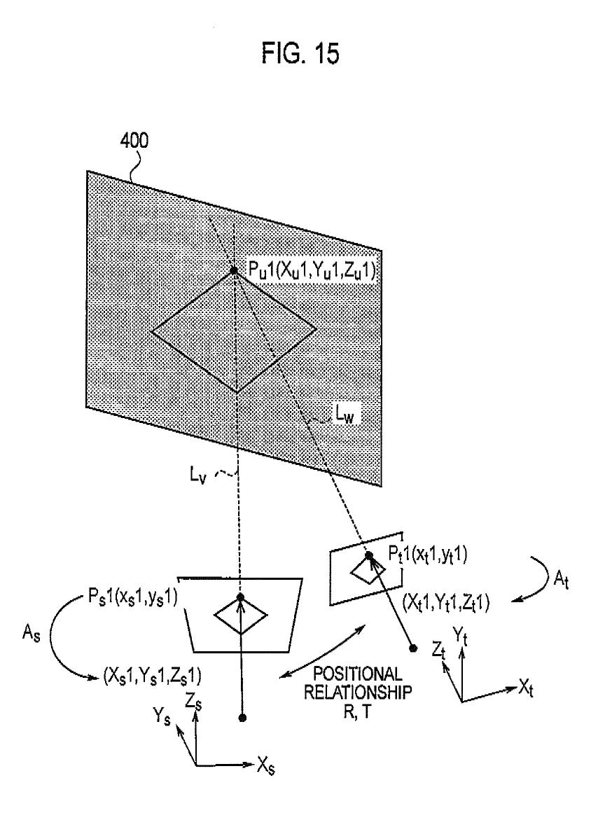

Hereinafter, a computation method of a coordinate (Xᵤ1, Yᵤ1, Zᵤ1) of the intersection point Pᵤ1 will be described with reference to FIG. 15. It should be noted that the coordinate (Xᵤ1, Yᵤ1, Zᵤ1) of the intersection point Pᵤ1 is a coordinate in a three-dimensional space in which a focal point Oₛ of the projection display apparatus 100 is defined as an origin.

(1) The computation unit 250 converts a coordinate (xₛ1, yₛ1) of a intersection point Pₛ1 in a two-dimensional plane of a storage test pattern image to a coordinate (Xₛ1, Yₛ1, Zₛ1) of a intersection point Pₛ1 in a three-dimensional space in which the focal point Oₛ of the projection display apparatus 100 is defined as an origin. Specifically, the coordinate (Xₛ1, Yₛ1, Zₛ1) of the intersection point Pₛ1 is represented by the formula below.

$$\begin{matrix}[ Mechanical Formula 9 ] & \\ ( \begin{matrix}{X}_{s} 1 \\ {Y}_{s} 1 \\ {Z}_{s} 1\end{matrix} ) = As ( \begin{matrix}{x}_{s} 1 \\ {y}_{s} 1 \\ 1\end{matrix} ) & Formula ( 10 )\end{matrix}$$

In the formula, As is a conversion matric of 3×3, and can be acquired in advance by means of preprocessing such as calibration. That is, As is a known parameter.

Here, perpendicular planes in an optical axis direction of the projection display apparatus 100 are represented by an Xₛ-axis and a Yₛ-axis, and the optical axis direction of the projection display apparatus 100 is represented by a Zₛ-axis.

Similarly, the computation unit 250 converts a coordinate (xt1, yt1) of a intersection point Pt1 in a two-dimensional plane of a captured test pattern image to a coordinate (Xₜ1, Yₜ1, Zₜ1) of a intersection point Pₜ1 in a three-dimensional space in which a focal point Oₜ of the imaging element 300 is defined as an origin.

$$\begin{matrix}[ Formula 10 ] & \\ ( \begin{matrix}{X}_{t} 1 \\ {Y}_{t} 1 \\ {Z}_{t} 1\end{matrix} ) = At ( \begin{matrix}{x}_{t} 1 \\ {y}_{t} 1 \\ 1\end{matrix} ) & Formula ( 11 )\end{matrix}$$

In the formula, At is a conversion matrix of 3×3, and can be acquired in advance by means of preprocessing such as calibration. That is, At is a known parameter.

Here, perpendicular planes in an optical axis direction of the imaging element 300 are represented by an Xₜ-axis and an Yₜ-axis, and an orientation of the imaging element 300 (an image capturing direction) is represented by a Zₜ-axis. In such a coordination space, it should be noted that a tilt (a vector) of the orientation of the imaging element 300 (an image capturing direction) is known.

(2) The computation unit 250 computes a formula of a straight line Lᵥ connecting an intersection point Pₛ1 and an intersection point Pᵤ1 to each other. Similarly, the computation unit 250 computes a formula of a straight line L_{w} connecting an intersection point Pₜ1 and an intersection point Pᵤ1 to each other. The formulas of the straight line Lᵥ and the straight line L_{w} are represented as follows.

$$\begin{matrix}[ Formula 11 ] & \\ {L}_{v} = ( \begin{matrix}{x}_{s} \\ {y}_{s} \\ {z}_{s}\end{matrix} ) = {K}_{s} ( \begin{matrix}{X}_{s} 1 \\ {Y}_{s} 1 \\ {Z}_{s} 1\end{matrix} ) & Formula ( 12 ) \\ {L}_{w} = ( \begin{matrix}{x}_{t} \\ {y}_{t} \\ {z}_{t}\end{matrix} ) = {K}_{t} ( \begin{matrix}{X}_{t} 1 \\ {Y}_{t} 1 \\ {Z}_{t} 1\end{matrix} ) & Formula ( 13 )\end{matrix}$$

In the formulas, Kₛ and Kₜ are parameters.

(3) The computation unit 250 converts the straight line L_{w} to a straight line L_{w}′ in a three-directional space in which a focal point Oₛ of the projection display apparatus 100 is defined as an origin. The straight line L_{w}′ is represented by the formula below.

$$\begin{matrix}[ Formula 12 ] & \\ {L}_{w}^{′} = ( \begin{matrix}{x}_{t}^{′} \\ {y}_{t}^{′} \\ {z}_{t}^{′}\end{matrix} ) = {K}_{t} R ( \begin{matrix}{X}_{t} 1 \\ {Y}_{t} 1 \\ {Z}_{t} 1\end{matrix} ) + T & Formula ( 14 )\end{matrix}$$

An optical axis of the projection display apparatus 11 and an orientation (an image capturing direction) of the imaging element 300 are known, and therefore, a parameter R indicating a rotational component is known. Similarly, relative positions of the projection display apparatus 100 and the imaging element 300 are known, and therefore, a parameter T indicating a translational component is also known.

(4) The computation unit 250 computes the parameters Kₛ and Kₜ at a intersection point between the straight line Lᵥ and the straight line L_{w}′ (i.e., a intersection point Pᵤ1), based on the formula (3) and the formula (5). Similarly, the computation unit 250 computes a coordinate (Xᵤ1, Yᵤ1, Zᵤ1) of an intersection point Pᵤ1, based on a coordinate (Xₛ1, Yₛ1, Zₛ1) of an intersection point Pₛ1 and Kₛ. Alternatively, the computation unit 250 computes a coordinate (Xᵤ1, Yᵤ1, Zᵤ1) of an intersection point Pᵤ1, based on a coordinate (Xₜ1, Yₜ1, Zₜ1) of an intersection point Pₜ1 and Kₜ.

In this manner, the computation unit 250 computes a coordinate (Xᵤ1, Yᵤ1, Zᵤ1) of the intersection point Pᵤ1. Similarly, the computation unit 250 computes a coordinate (Xᵤ2, Yᵤ2, Zᵤ2) of the intersection point Pᵤ2, a coordinate (Xᵤ3, Yᵤ1, Zᵤ3) of the intersection point Pᵤ3, and a coordinate (Xᵤ4, Yᵤ4, Zᵤ4) of the intersection point Pᵤ4.

Second, the computation unit 250 computes a vector of a normal line M of the projection surface 400. Specifically, the computation unit 250 computes the vector of the normal line M of the projection surface 400 by employing the coordinates of at least three or more intersection points from among the intersection point Pᵤ1 to the intersection point Pᵤ4. A formula of the projection surface 400 is represented as follows, and parameters k₁, k₂, and k₃ designate the vector of the normal line M of the projection surface.

[Formula 13]

k₁x+k₂y+k₂z+k₄=0 Formula (15)

In the formula, k₁, k₂, k₃, and k₄ are predetermined coefficients. In this manner, the computation unit 250 can compute a displacement quantity between an optical axis N of the projection display apparatus 100 and the normal line M of the projection surface 400. That is, the computation unit 250 can compute a positional relationship between the projection display apparatus 100 and the projection surface 400.

While the first embodiment has described the specifying unit 240 and the computation unit 250 separately, the specifying unit 240 and the computation unit 250 may be considered to be one configuration. For example, the computation unit 250 may have a function of the specifying unit 240.

Turning to FIG. 4, the element control unit 260 converts an image input signal to an image output signal, and controls a liquid crystal panel 50, based on the converted image output signal. In addition, the element control unit 260 has a function shown below.

Specifically, the element control unit 260 has a function of performing automatic correction of a shape of an image projected onto the projection surface 400, based on a positional relationship between the projection display apparatus 100 and the projection surface 400 (shape adjustment). That is, the element control unit 260 has a function of automatically performing trapezoidal correction, based on the position relationship between the projection display apparatus 100 and the projection surface 400.

The projection unit adjustment unit 270 controls a lens group arranged in the projection unit 110. First, the projection unit adjustment unit 270 incorporates the projectable range 410 in the display frame 420 arranged on the projection surface 400, by means of a shift of the lens group arranged in the projection unit 110 (zoom adjustment). Specifically, the projection unit adjustment unit 270 controls the lens group arranged in the projection unit 110 so that the projectable rang 410 is incorporated in the display frame 420, based on a captured image of a frame detection pattern image acquired by means of the acquisition unit 230.

Second, the projection unit adjustment unit 270 adjusts a focus of the image projected onto the projection surface 400, by means of a shaft of the lens group arranged in the projection unit 110 (focus adjustment). Specifically, the projection unit adjustment unit 270 controls the lens group arranged in the projection unit 110, based on a captured image of a focus adjustment image acquired by the acquisition unit 230, so that a focus value of the image projected onto the projection surface 400 is obtained as a maximum value.

The element control unit 260 and the projection unit adjustment unit 270 configure an adjustment unit 280 that adjusts the image projected onto the projection surface 400.

Here, the projection display apparatus 100 may specify a line segment included in a test pattern image for an entire test pattern image and compute a positional relationship between the projection display apparatus 100 and the projection surface 400 (a batch processing mode). That is, in the batch processing mode, the imaging element 300 captures the entire test pattern image in a state in which a focus has been adjusted for the entire projectable range 410, and the projection display apparatus 100 specifies three or more line segments included in the test pattern image, based on the captured image of the entire test pattern image.

Alternatively, the projection display apparatus 100 may specify a line signal included in a test pattern image for a respective one of a plurality of image regions divided so as to partially include the test pattern image, and compute a positional relationship between the projection display apparatus 100 and the projection surface 400 (dividing processing mode). That is, in the dividing processing mode, the imaging element 300 captures the test pattern image in a plurality of regions in a state in which a focus has been adjusted in a plurality of image region, and the projection display apparatus 100 specifies three or more line segments included in the test pattern image, based on a captured image of the test pattern image in a plurality of regions.

### (Operation of Projection Display Apparatus)

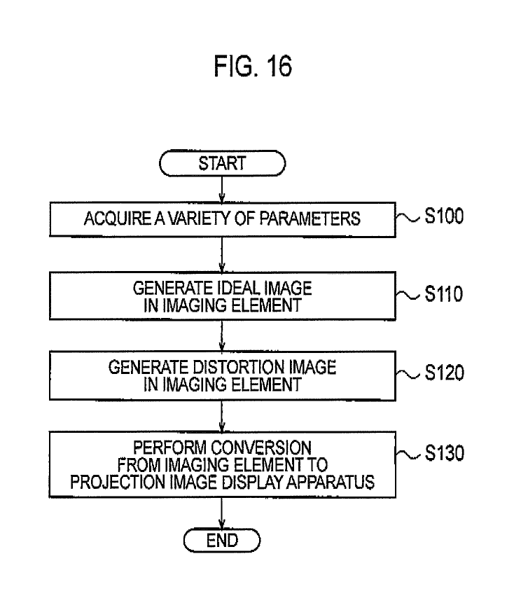

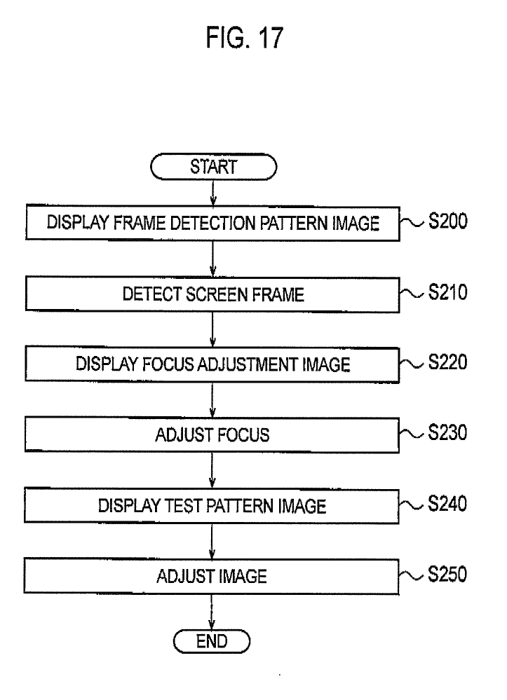

Hereinafter, an operation of a projection display apparatus (a control unit) according to the first embodiment will be described with reference to the drawings. FIG. 16 and FIG. 17 are flowcharts each showing an operation of a projection display apparatus 100 (a control unit 200) according to the first embodiment.

First, a method for computing a test pattern image to which a distortion in an opposite direction to that of a lens is assigned will be described with reference to FIG. 16.

As shown in FIG. 16, in step 100, the projection display apparatus 100 acquires a variety of parameters. As the parameters, this apparatus acquires parameters (cₓ, c_{y}, p₁, p₂, q₁, and q₂) for correcting a lens distortion and parameters (At, As, R, and T) for converting a two-dimensional spatial coordinate to a three-dimensional spatial coordinate.

In step 110, the projection display apparatus 100 acquires a coordinate (xₛ, yₛ, 1) of an ideal test pattern camera image in a test pattern image captured by the imaging element 300.

In step S120, the projection display apparatus 100 converts the ideal test pattern camera image and computes a coordinate (xₛ′, yₛ′, 1) of a test pattern camera image after distortion correction, by employing the formula (1) and the formula (2) described above.

In step 130, the projection display apparatus 100 converts the coordinate (xₛ′, yₛ′, 1) of the test pattern camera image after distortion correction, from a coordinate in a two-dimensional space of an image captured by the imaging element 300 to a coordinate in a two-dimensional space of an image stored in the projection display apparatus 100.

In detail, as described above, the coordinate in the two-dimensional space of the image captured by the imaging element 300 is converted to a coordinate in a three-dimensional space in which a focal point of the imaging element 300 is defined as an origin. Subsequently, the coordinate in the three-dimensional space in which the focal point of the imaging element 300 is defined as an origin is converted to a coordinate in a three-dimensional space in which a focal point of the projection display apparatus 100 is defined as an origin is converted to a coordinate in a two-dimensional space of an image stored in the projection display apparatus 100. Subsequently, the coordinate in the three-dimensional space in which the focal point of the projection display apparatus 100 is defined as an origin is converted to a coordinate in a two-dimensional space of an image stored in the projection display apparatus 100.

Second, a method for adjusting a shape of an image or the like will be described with reference to FIG. 17. As shown in FIG. 17, in step 200, the projection display apparatus 100 displays (projects) a frame detection pattern image on the projection surface 400. The frame detection pattern image is a white image or the like, for example.

In step 210, the imaging element 300 arranged in the projection display apparatus 100 captures an image on the projection surface 400. That is, the imaging element 300 captures a frame detection pattern image provided on the projection surface 400. Subsequently, the projection display apparatus 100 detects the display frame 420 arranged on the projection surface 400, based on a captured image of the frame detection pattern image.

In step 220, the projection display apparatus 100 displays (projects) a focal adjustment image on the projection surface 400.

In step 230, the imaging element 300 arranged in the projection display apparatus 100 captures an image on the projection surface 400. That is, the imaging element 300 captures a focus adjustment image projected onto the projection surface 400. Subsequently, the projection display apparatus 100 adjusts a focus of the focus adjustment image so that a focus value of the focus adjustment image is obtained as a maximum value.

In step 240, the projection display apparatus 100 displays (projects) a test pattern image on the projection surface 400.

In step 250, the imaging element 300 arranged in the projection display apparatus 100 captures an image on the projection surface 400. That is, the imaging element 300 captures the test pattern image projected onto the projection surface 400. Subsequently, the projection display apparatus 100 specifies four line segments (Lₜ1 to Lₜ4) included in the captured test pattern image, and specifies four intersection points (Pₜ1 to Pₜ4) included in the captured test pattern image, based on the four line segments (Lₜ1 to Lₜ4). The projection display apparatus 100 computes a positional relationship between the projection display apparatus 100 and the projection surface 400, based on four cross points (Pₛ1 to Pₛ4) included in a storage test pattern image and the four intersection points (Pₜ1 to Pₜ4) included in the captured test pattern image. The projection display apparatus 100 adjusts a shape of an image projected onto the projection surface 400, based on the positional relationship between the projection display apparatus 100 and the projection surface 400 (trapezoidal correction).

### (Functions and Advantageous Effects)

In the first embodiment, the element control unit 260 controls the liquid crystal panel 50 so as to display a test pattern image having a distortion in an opposite direction to that of a lens. In other words, a distortion of a captured image of the test pattern image is canceled by preparing in advance the test pattern image having the distortion in the opposite direction to that of the lens, so that a processing time or a cost required to adjust the shape of the image projected onto the projection surface 400 can be restrained.

In the first embodiment, three or more line segments included in a test pattern image respectively has a tilt relative to a predetermined line. Firstly, the number of pixels to be sampled to perform edge detection or the like can be reduced in comparison with a case in which the line segments included in the test pattern image are taken along a predetermined line. Therefore, a processing load on image adjustment can be reduced. Secondly, detection precision of the line segments included in the test pattern image is improved in comparison with a case in which the line segments included in the test pattern image are taken along the predetermined line.

### MODIFICATION EXAMPLE 1

Hereinafter, modification example 1 of the first embodiment will be described. Hereinafter, matters different from those of the first embodiment will be mainly described.

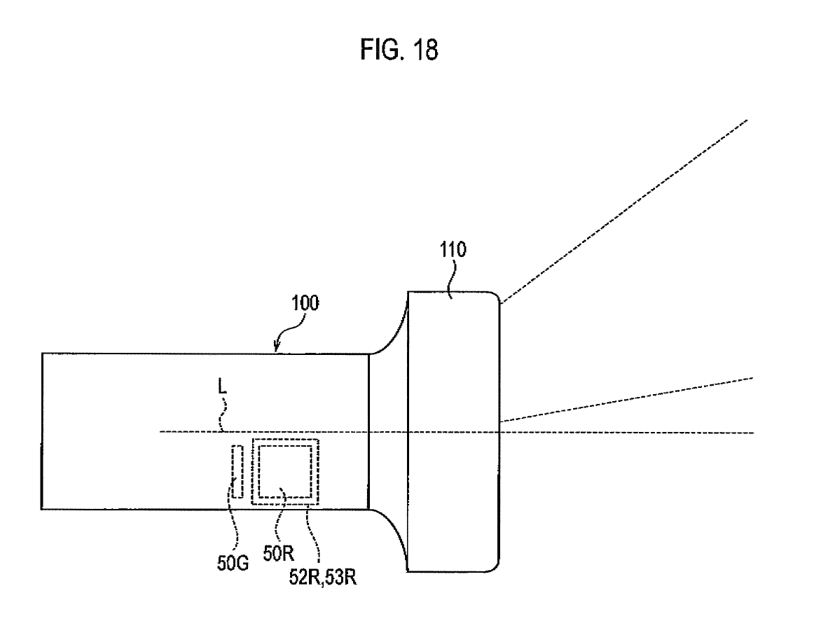

Specifically, the first embodiment described a case in which a projection unit 110 has a reflection mirror 112. On the other hand, in modification example 1, as shown in FIG. 18, the projection unit 110 does not have the reflection mirror 112. In such a case, it should be noted that a projection lens group 111 arranged in the projection unit 110 includes a widely angled lens.

In modification example 1 as well, a liquid crystal panel 50, as shown in FIG. 18, is disposed at a position shifted from an optical axis center L of the projection unit 110.

### Other Embodiments

While the present invention has been described by way of the foregoing embodiment, it should not be understood that the discussion and drawings forming a part of this disclosure limit the invention. From this disclosure, a variety of substitute embodiments, examples, and operational technique would have been self-evident to one skilled in the art.

The foregoing embodiment illustrated an incandescent light source as a light source. However, the light source may be an LED (a Light Emitting Diode), an LD (a Laser Diode), or an EL (an Electra Luminescence).

The foregoing embodiment illustrated a transmission liquid crystal panel as an imager. However, the imager may be a reflection liquid crystal panel or a DYED (a Digital Micro-mirror Device).

Although not set forth in the foregoing embodiment, it is preferable that the element control unit 260 control the liquid crystal panel 50 so as not to display an image until a test pattern image is displayed after the display frame 420 has been detected.

Although not set forth in the foregoing embodiment, it is preferable that the element control unit 260 control the liquid crystal panel 50 so as not to display an image until a shape of an image projected onto the projection surface 400 is corrected after three or more intersection points included in a captured test pattern image has been acquired.

Although not set forth in the foregoing embodiment, it is preferable that the element control unit 260 control the liquid crystal panel 50 so as to display a test pattern image and a predetermined image (for example, a background image) other than the test pattern image.

For example, a test pattern image is configured with a color or a luminance that can be detected by means of the imaging element 300, and a predetermined image other than the test pattern image is configured by a color or a luminance that cannot be detected by means of the imaging element 300.

Alternatively, among red, green, and blue, a test pattern image is configured with any color, and a predetermined image other than the test pattern image is configured with any other color. The imaging element 300 can acquire a captured image of the test pattern image by detecting only the at least one color that configures the test pattern image.

In addition, in a case where no image signal is input, the element control unit 260 may control the liquid crystal panel 50 so as to display an error message as a predetermined image together with a test pattern image. Alternatively, in a case where a line segment or an intersection point included in a test pattern image cannot be specified, the element control unit 260 may control the liquid crystal panel 50 so as to display an error message as a predetermined image.

In the foregoing embodiment, the projection display apparatus 100 adjusts a focus after detecting the display frame 420. However, the embodiment is not limitative thereto. For example, the projection display apparatus 100 may adjust a focus without a need to detect the display frame 420. Specifically, in a normal use mode, it is presupposed that a center portion of the projectable range 410 is included in the display frame 420, so that the projection display apparatus 100 may display a focus adjustment image at the center portion of the projectable range 410 and may adjust a focus of an image (a focus adjustment image) displayed at the center portion of the projectable rage 410.

In the embodiment, of a test pattern image, a background portion is black, and a pattern portion is white. However, the embodiment is not limitative thereto. For example, the background portion may be white, and the pattern portion may be black. The background portion may be blue, and the pattern portion may be white. That is, there may be a difference in luminance between the background portion and the pattern portion to an extent such that edge detection is possible. The extent such that edge detection is possible is determined according to precision of the imaging element 300. As the difference in luminance between the background portion and the pattern portion increases, of course, the precision of the imaging element 300 is less required, thus enabling cost reduction of the imaging element 300.

While a line segment is a line connecting two points to each other, such a line segment is not limitative to a straight line. Specifically, a test pattern image stored in the storage unit 220, as described above, has a distortion, and therefore, it should be noted that a line segment is obtained as a curve connecting two points to each other in the test pattern image stored in the storage unit 220. In addition, in a test pattern image captured by means of the imaging element 300 through a lens having a distortion in a positive direction or in a negative direction, a line segment may be a curve connecting two points to each other. In such a case, it should be noted that a parameter for specifying such a curve is stored in advance so that a cross point of the line segment can be computed.

What is claimed is:

1. A projection display apparatus having an imager that modulates light emitted from a light source and a projection unit that projects light emitted from the imager onto a projection surface, the projection display apparatus comprising:
an element control unit that controls the imager so as to display a test pattern image formed of at least parts of three or more line segments defining three or more intersection points;
an acquisition unit that acquires a captured image of the test pattern image output from an imaging element that captures the test pattern image projected onto the projection surface;
a computation unit that specifies three or more intersection points from the three or more line segments included in the captured image, based on the captured image acquired by the acquisition unit and that computes a positional relationship between the projection display apparatus and the projection surface, based on the three or more intersection points; and
an adjustment unit that adjusts the image provided on the projection surface, based on the positional relationship between the projection display apparatus and the projection surface, wherein
the imaging element captures the test pattern image through a lens having a distortion in a positive direction or in a negative direction, and
the element control unit controls the imager so as to display the test pattern image having a distortion in an opposite direction to a direction of the lens.

2. The projection display apparatus according to claim 1, wherein the distortion included in the test pattern image is a yarn winding distortion.

3. The projection display apparatus according to claim 1, wherein the imager is disposed at a position shifted from an optical axis center of the projection unit.

4. The projection display apparatus according to claim 1, wherein
the projection unit is comprised of a lens group and a reflection mirror that reflects light transmitting the lens group onto the projection surface.

5. An image adjustment method applied to a projection display apparatus having an imager that modulates light emitted from a light source and a projection unit that projects light emitted from the imager onto a projection surface, the image adjustment method comprising the following steps:
the step A of displaying a test pattern image formed of at least parts of three or more line segments defining three or more intersection points;
the step B of imaging the test pattern image projected onto the projection surface through a lens having a distortion in a positive direction or in a negative direction and acquiring a captured image of the test pattern image; and
the step C of computing a positional relationship between the projection display apparatus and the projection surface, based on the captured image, and adjusting an image projected onto the projection surface, based on the positional relationship between the projection display apparatus and the projection surface, wherein
the step A includes displaying the test pattern image having a distortion in an opposite direction of a direction of the lens.
